(19) United States
(12) Patent Application Publication
(10) Pub. No.: US 2024/0193010 A1
(43) Pub. Date: Jun. 13, 2024

(54) SYSTEM, APPARATUS AND METHOD FOR CLOUD RESOURCE ALLOCATION

(71) Applicant: Industrial Technology Research Institute, Hsinchu (TW)

(72) Inventors: Chun-Chieh Huang, Taoyuan City (TW); Tzu-Chia Wang, New Taipei City (TW); Chien-Hung Lee, Kaohsiung City (TW); Yi-Lin Wu, Yilan County (TW); Guo-Hong Lai, Taipei City (TW); Lin-Kang Wu, Taoyuan City (TW)

(73) Assignee: Industrial Technology Research Institute, Hsinchu (TW)

(21) Appl. No.: 18/183,161

(22) Filed: Mar. 14, 2023

(30) Foreign Application Priority Data
Dec. 9, 2022 (TW) 111147322

(51) Int. Cl. G06F 9/54; G06F 9/48

(52) U.S. Cl. CPC G06F 9/54; G06F 9/4881

(57) ABSTRACT

A system, an apparatus, and a method for cloud resource allocation are provided. The cloud resource allocation system includes a plurality of worker nodes and a master node. The master node includes: an orchestrator configured to: obtain multiple node resource information respectively reported by a plurality the worker nodes through a resource manager; and parse a job profile of a job request obtained from the waiting queue through the job scheduler and decide to execute a direct resource allocation or a preemptive indirect resource allocation for a job to be handled requested by the job request based on the node resource information and the job profile.

### CROSS-REFERENCE TO RELATED APPLICATION

This application claims the priority benefit of Taiwan application serial no. 111147322, filed on Dec. 9, 2022. The entirety of the above-mentioned patent application is hereby incorporated by reference herein and made a part of this specification.

### TECHNICAL FIELD

The disclosure relates to a system, an apparatus, and a method for cloud resource allocation.

### DESCRIPTION OF RELATED ART

In the global market of cloud computing and edge computing, with the popularity of various new technologies and applications, the global market size of cloud computing and edge computing continues to grow. The growing popularity of IoT technology in various industries is driving the growth of the global edge computing market.

Cloud computing provides lightweight container services that support real-time application services. Cloud applications (e.g., metaverse, cloud games, artificial intelligence monitoring) have characteristics of multi-service and instant response. Currently, container orchestration technology is equipped with preemptive resource management, and priority is set for multiple services to provide quality of service (QOS) guaranteed container provisioning. A container is a lightweight code package in an application that includes dependency elements such as runtime-specific versions of programming languages, environment configuration files, and libraries needed for executing software services.

The time-consuming of cold start ranges from hundreds of milliseconds to several seconds, which is unable to effectively support instant provisioning of containers and low-latency application services. At present, a design with container pre-launch is proposed, which is supplemented by a workload prediction mechanism to meet the real-time provisioning and operation requirements of low-latency applications. However, this design does not consider the impact of workload management on power efficiency.

Cloud computing supports a variety of QoS-sensitive application services, and the priority scheduling mechanism ensures the resource usage efficiency of high priority services. The resource orchestration mechanism (cloud orchestration) is of considerable importance since cloud orchestration performs “automatic configuration of application services” and “optimization of resources” according to the functional characteristics and resource requirements of application services. Therefore, the variety of applications has also driven the growth of the global cloud orchestration market.

Accordingly, in the field of cloud resource orchestration, how to balance “job performance” and “energy saving and consumption reduction” is one of the current topics.

### SUMMARY

The disclosure provides a system, an apparatus, and a method for cloud resource allocation, which considers job performance and energy saving.

The cloud resource allocation system of the disclosure includes multiple worker nodes and a master node. The master node includes: an orchestrator configured to: obtain multiple node resource information respectively reported by the worker nodes through a resource manager; and parse a job profile of a job request obtained from the waiting queue through the job scheduler and decide to execute a direct resource allocation or an indirect resource allocation for a job to be handled requested by the job request based on the node resource information and the job profile. In response to deciding to execute the direct resource allocation, the orchestrator is configured to: find a first worker node having an available resource matching the job profile through the job scheduler among the worker nodes; dispatch the job to be handled to the first worker node through the resource manager; and put the job to be handled into a running queue through the job scheduler. In response to executing the indirect resource allocation, the orchestrator is configured to: through the job scheduler, find a second worker node having a low priority job among the worker nodes, notify the second worker node so that the second worker node backs up an operation mode of the low priority job, and then release resource used by the low priority job; put another job request corresponding to the low priority job into the waiting queue through the job scheduler in response to receiving a resource release notification from the second worker node through the resource manager; dispatch the job to be handled to the first worker node through the resource manager; and put the job to be handled into a running queue through the job scheduler.

The cloud resource allocation apparatus of the disclosure includes a storage, storing an orchestrator and providing a waiting queue and a running queue, wherein the orchestrator includes a resource manager and a job scheduler; and a processor, coupled to the storage, configured to: obtain multiple node resource information respectively reported by the worker nodes through the resource manager; and parse a job profile of a job request obtained from the waiting queue through the job scheduler and decide to execute a direct resource allocation or an indirect resource allocation for a job to be handled requested by the job request based on the node resource information and the job profile.

The cloud resource allocation method of the disclosure includes executing the following through a cloud resource allocation apparatus. Multiple node resource information respectively reported by multiple worker nodes is obtained; a job profile of a job request obtained from a waiting queue is parsed and a direct resource allocation or an indirect resource allocation for a job to be handled requested by the job request is decided to be executed based on the node resource information and the job profile.

Based on the above, the disclosure provides an orchestration architecture with dynamic management of performance and power consumption and an application group job preemption mechanism based on this architecture. Considering the application supported by multiple jobs, job management is flexible based on the application priority, and the power usage efficiency of node computing resources while supporting the operation performance of container services is considered, thereby reducing maintenance and operation costs.

### BRIEF DESCRIPTION OF THE DRAWINGS

FIG. 1 is a block diagram of a cloud resource allocation system according to an embodiment of the disclosure.

FIG. 2 is a flowchart of a cloud resource allocation method according to an embodiment of the disclosure.

FIG. 3 is a schematic view of an architecture of a cloud resource allocation apparatus according to an embodiment of the disclosure.

FIG. 4 is a schematic view of an architecture of worker nodes according to an embodiment of the disclosure.

FIG. 5 is a block diagram of integration mode nodes according to an embodiment of the disclosure.

FIG. 6 is a schematic view of performance/power consumption monitoring of worker nodes according to an embodiment of the disclosure.

FIG. 7 is a flowchart of the performance/power consumption monitoring of worker node according to an embodiment of the disclosure.

FIG. 8 is a schematic view of a container resource request and a resource orchestration according to an embodiment of the disclosure.

FIG. 9 is a schematic view of power consumption adjustment according to an embodiment of the disclosure.

FIG. 10 is a schematic view of performance adjustment according to an embodiment of the disclosure.

FIG. 11A to FIG. 11C are schematic views of job profiles of job requests according to an embodiment of the disclosure.

FIG. 12A to FIG. 12E are the schematic views of distribution of job requests according to an embodiment of the disclosure.

FIG. 13 is a schematic view of job dependency and resource check according to an embodiment of the disclosure.

### DETAILED DESCRIPTION OF DISCLOSED EMBODIMENTS

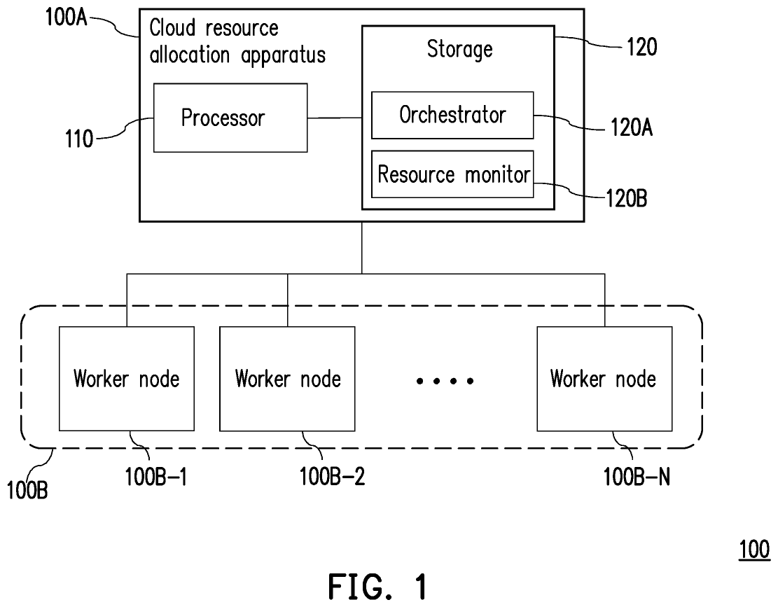

FIG. 1 is a block diagram of a cloud resource allocation system according to an embodiment of the disclosure. Referring to FIG. 1, divided by functions, the cloud resource allocation system 100 includes two node types, a master node (cloud resource allocation apparatus 100A) and worker nodes 100B-1˜100B-N (collectively referred to as worker nodes 100B). The cloud resource allocation apparatus 100A is configured to manage and schedule container computing resources. The worker nodes 100B provide container computing resources.

The operation architecture of the cloud resource allocation system 100 may have various modes as follows: basic mode having at least one master node (cloud resource allocation apparatus 100A) and at least two worker nodes 100B, high availability mode having at least three master nodes (cloud resource allocation apparatus 100A) and at least two worker nodes 100B, integration mode having (at least two) nodes running the integration mode and deploying the elements forming the master node and the worker node, high availability integration mode having at least three nodes running the integration mode, and distributed integration mode, having at least two nodes running the integration mode and no function group disposed, and using point-to-point communication to collect global information to achieve the purpose of decentralized resource orchestration.

The cloud resource allocation apparatus 100A is realized by using an electronic device with computing function and networking function, and the hardware architecture thereof includes at least a processor 110 and a storage 120. The worker nodes 100B are also realized by using an electronic device with computing function and networking function, and the hardware architecture thereof is similar to that of the cloud resource allocation apparatus 100A.

The processor 110 is, for example, a central processing unit (CPU), a physics processing unit (PPU), a programmable microprocessor, an embedded control chip, a digital signal processor (DSP), an application specific integrated circuits (ASIC), or other similar devices.

The storage 120 is, for example, any type of repaired or removable random access memory (RAM), read-only memory (ROM), flash memory, hard disk, or other similar device or a combination of these devices. The storage 120 includes an orchestrator 120A and a resource monitor 120B. The orchestrator 120A and the resource monitor 120B are formed by one or more code fragments. The above code fragments are executed by the processor 110 after being installed. In other embodiments, the orchestrator 120A and the resource monitor 120B is also implemented by independent chip, circuit, controller, CPU, and other hardware.

The orchestrator 120A manages job requests and schedules container resources. The resource monitor 120B receives the node resource information actively reported by the worker nodes 100B. For example, the node resource information includes workload monitoring data checked for workload and power consumption monitoring data checked for power consumption.

The orchestrator 120A controls the resource scheduling capability of the worker nodes 100B, thereby meeting the requirement of quality of service of the application. The requirement of quality of service includes the requirement of job resource usage, such as CPU resource, memory resource, hard disk resource, etc. The requirement of quality of service further includes priority-level scheduling requirements, for example, based on importance and deadline. Resource orchestration is carried out first on the job with a higher priority.

The resource monitor 120B is configured to collect the node resource information of the worker nodes 100B as a whole and master all configurable container computing resources and the available resource type and capacity of the worker nodes 100B for providing computing resources.

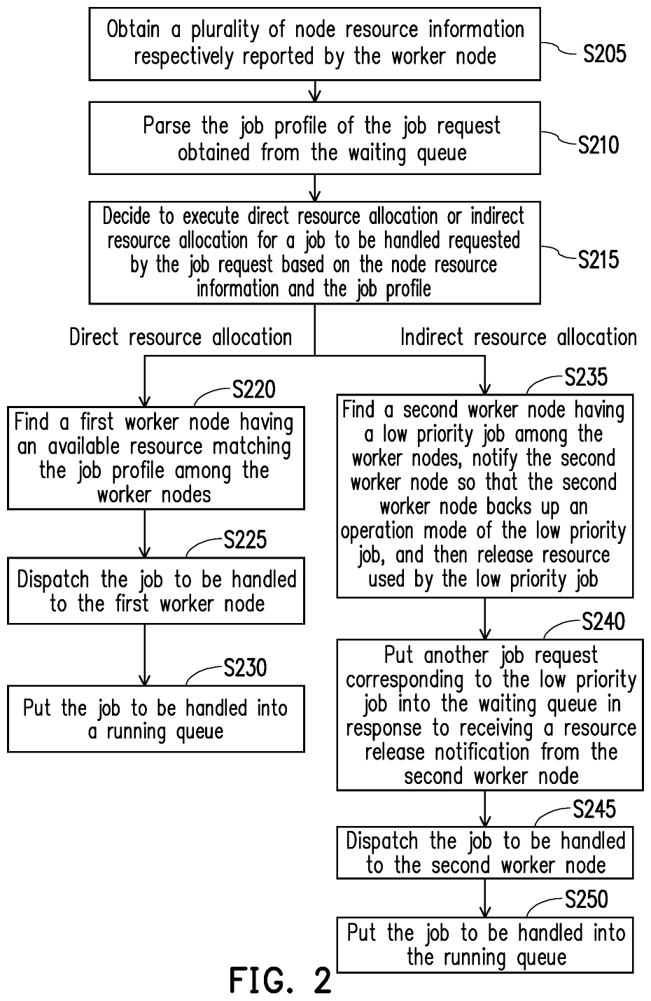

FIG. 2 is a flowchart of a cloud resource allocation method according to an embodiment of the disclosure. Referring to FIG. 1 and FIG. 2, in step S205, the cloud resource allocation apparatus 100A obtains multiple node resource information respectively reported by the worker nodes 100B-1˜100B-N through the resource monitor 120B.

Next, in step S210, the orchestrator 120A parses the job profile of the job request obtained from the waiting queue and decides to execute direct resource allocation or indirect resource allocation for a job to be handled requested by the job request. Specifically, the job profile includes multiple jobs based on application group, priority, resource requirements (e.g., resource type and demand) required by each of the jobs (application group members) during the execution, startup sequence and shutdown sequence that support multiple application group members (job container), etc.

In step S215, the orchestrator 120A determines whether the available resources of the worker nodes 100B-1˜100B-N meet the resource requirement of the job request based on the node resource information and the job profile. If the available resource of at least one of the worker nodes 100B meets the resource requirement of the job request, the direct resource allocation is decided to be executed for the job to be handled. If the available resource of none of the worker nodes 100B meets the resource requirement of the job request, and if it is evaluated that the resource requirement of the job request is met (meeting the resource preemption condition) after preempting the resources used by one or more low priority jobs (i.e., one or more running jobs with low priority), it is then decided to perform the indirect resource allocation on the job to be handled.

In response to deciding to execute the direct resource allocation, the orchestrator 120A executes steps S220-S230. In step S220, a first worker node having an available resource matching the job profile is found among the worker nodes 100B. Next, in step S225, the job to be handled is dispatched to the first worker node. After that, in step S230, the job to be handled is put into the running queue.

In response to deciding to execute the indirect resource allocation, the orchestrator 120A executes steps S235-S250. In step S235, a second worker node having a low priority job is found among the worker nodes 100B, the second worker node is notified so that the second worker node backs up an operation mode of the low priority job, and then resource used by the low priority job is released. Next, in step S240, another job request corresponding to the low priority job is put into the waiting queue in response to receiving a resource release notification from the second worker node. And, in step S245, the job to be handled is dispatched to the second worker node. After that, in step S250, the job to be handled is put into the running queue. The second worker node is notified to continuously release resource used by another low priority job until an adjusted available resource meets the resource requirement of the job request in response to the adjusted available resource that still does not meet the resource requirement of the job request after releasing the resource used by the low priority job.

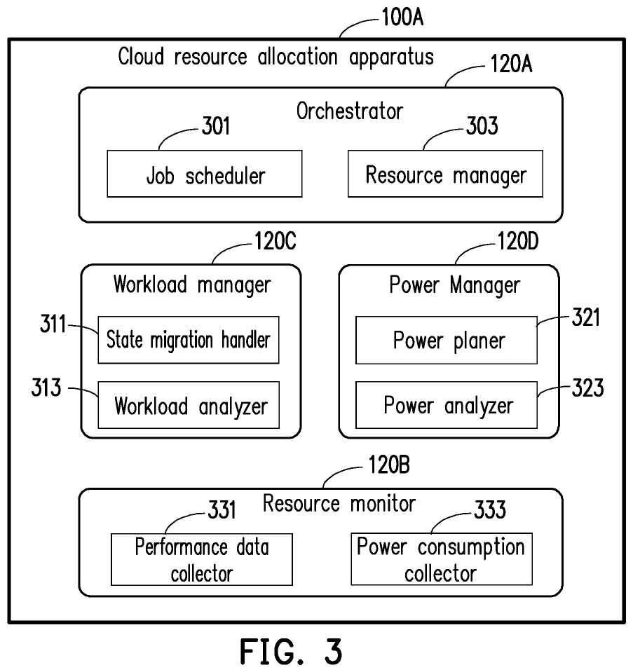

FIG. 3 is a schematic view of an architecture of a cloud resource allocation apparatus according to an embodiment of the disclosure. Referring to FIG. 3, the cloud resource allocation apparatus 100A includes an orchestrator 120A, a resource monitor 120B, a workload manager 120C, and a power manager 120D.

The orchestrator 120A includes a job scheduler 301 and a resource manager 303. The job scheduler 301 is configured to parse the job profile of the job request and decide to execute the resource allocation in a direct or indirect (preemptive) manner according to parsed job profile (respectively referred to as direct resource allocation and indirect resource allocation). The job scheduler 301 is further configured to manage the operation mode. Moreover, the job scheduler 301 further provides a waiting queue and a running queue. The waiting queue is configured to accommodate pending job requests (new job requests, preempted job requests) and job requests with higher priority are prioritized for scheduling jobs. The running queue is configured to accommodate the running jobs. Backup operation of the operation mode is first executed on the low priority job whose resource will be preempted. Moreover, when entering the waiting queue later for retrieving the container resource after the resource is released, the unfinished job is continued from the previous operation mode.

The job to be handled is deleted from the running queue through the job scheduler 301 in response to receiving a notification indicating that the job to be handled has ended through the resource manager 303 after the job scheduler 301 putting the job to be handled into the running queue.

The job scheduler 301 supports scheduling results of different job goals. The job goal is, for example, the minimum power consumption cost, the best performance, or a comprehensive measurement goal. Regarding the minimum power consumption cost, the worker node 100B with the lowest power consumption cost is found by confirming the basic power consumption of the system of each of the worker nodes 100B and the power consumption information corresponding to the current load state, and evaluating the power consumption cost of each of the worker nodes 100B executing the job request according to the resource requirements amount and history data of the job request. Regarding the best performance, the worker nodes 100B capable for configuring the highest resource level on the premise of meeting the resource requirement of the job request is selected by confirming the category, level, and available capacity of the resources of each of the worker nodes 100B. Regarding the comprehensive measurement goal, for example, the worker node with a specific ratio of performance and power consumption is considered. Moreover, the job scheduler 301 may also provide a corresponding worker node list based on the minimum power consumption cost, the best performance, and the comprehensive measurement goal.

The resource manager 303 is configured to manage the resources and control the node resource information actively reported by all worker nodes 100B, including workload monitoring data and power consumption monitoring data of each of the worker nodes. The workload monitoring data includes: the total load and available resources of the worker nodes. The power consumption monitoring data includes: power consumption statistics and energy efficiency, multi-level (worker node level, job group level, job schedule level) performance and power consumption statistics and analysis information, and possible performance and power consumption adjustment strategy suggestions. The resource manager 303 may provide statistical information related to performance and power consumption to the job scheduler 301, so as to support the same to complete the decision-making of job scheduling. The resource manager 303 dispatches the job to be handled requested by the job request to the designated worker node 100B for execution according to the scheduling result of the job scheduler 301. The resource manager 303 may also perform active performance adjustment and/or power consumption adjustment.

The resource monitor 120B includes a performance data collector 331 and a power consumption collector 333. The performance data collector 331 is configured to collect and save the workload monitoring data reported by each of the worker nodes 100B, and append history data to the workload monitoring data based on a preset time in response to the workload monitoring data being marked with a warning label. For example, if the workload of the worker node 100B exceeds a preset workload upper bound, the performance data collector 331 will append the history data of workload for subsequent analysis according to a preset period of time.

The power consumption collector 333 is configured to collect and save the power consumption monitoring data reported by each of the worker nodes 100B. If a container life cycle event (e.g., creation, preemption, termination) occurs on the worker node 100B, a process identifier (PID) change is generated, and power consumption history data related to the PID is appended for subsequent analysis according to a preset period of time.

The workload manager 120C is configured to perform performance management according to the workload monitoring data, and the monitoring data is eventually used as the basis for scheduling resources by the orchestrator. The workload manager 120C includes a state migration handler 311 and a workload analyzer 313.

The state migration handler 311 processes the state migration between the worker nodes 100B according to the instruction of the resource manager 303.

The workload analyzer 313 mainly receives the workload monitoring data from the performance data collector 331 and determines whether a resource abnormality occurs in the worker nodes 100B by analyzing the workload monitoring data. The workload analyzer 313 notifies the resource manager 303 in response to determining that the resource abnormality is a workload excess (the workload of each of the worker nodes 100B exceeding a preset workload upper bound) or a system resource loss (insufficient system resources caused by system resource loss mainly occurs in response to the computer program not releasing the occupied resources normally when the computer program ends; as a result, resources that have not been released normally are not allocated to any job request, resulting in possible resource starvation, performance degradation, system crashes, etc.), so that the resource manager 303 transmits state migration command to a state migration handler 311.

The workload analyzer 313 is configured to generate a corresponding state migration suggestion for the worker node 100B where resource abnormality occurs. The workload analyzer 313 generates a job group level state migration suggestion in response to determining that the resource abnormality is the workload excess; the workload analyzer 313 generates a node level state migration suggestion in response to determining that the resource abnormality is the system resource loss (e.g., memory leak).

The power manager 120D includes a power planer 321 and a power analyzer 323. The power planer 321 generates a power adjustment suggestion (power consumption adjustment of the worker nodes) based on the power consumption adjustment strategy (indicated by the resource manager 303), so as to transmit the power adjustment suggestion to the worker node 100B.

The power analyzer 323 receives the power consumption monitoring data from the power consumption collector 333, obtains a power consumption analysis result by analyzing the power consumption monitoring data, and generates a power consumption adjustment strategy based on the power consumption analysis result. In an embodiment, the power analyzer 323 performs power consumption analysis based on the life cycle management events (e.g., creation, deletion, state migration) of the container on the worker nodes and provides the resource manager 303 with a suitable power consumption adjustment strategy. The power planer 321 plans a suitable power adjustment suggestion based on the power consumption adjustment strategy.

For example, if there is no power consumption of any job schedule on a worker node 100B, it is suggested in the power adjustment suggestion that the worker node go into sleep mode. If the power consumption configuration on a worker node 100B is too high, which is significantly higher than the current workload, it is suggested in the power adjustment suggestion that the worker node performs dynamic voltage and frequency scaling (DVFS). For example, “performance” (the CPU repairs the job at the highest supported frequency) is adjusted to “powersave” (the CPU repairs the job at the lowest supported frequency).

In addition, if all running worker nodes 100B are fully loaded, the power planer 321 issues a power on command to the worker nodes in sleep mode or powered off mode, such as a worker node 100B-i. And after the worker node 100B-i in the sleep mode or powered off mode transits to the operation mode, the node resource information respectively reported by the worker node 100B-i and other worker nodes 100B is obtained again.

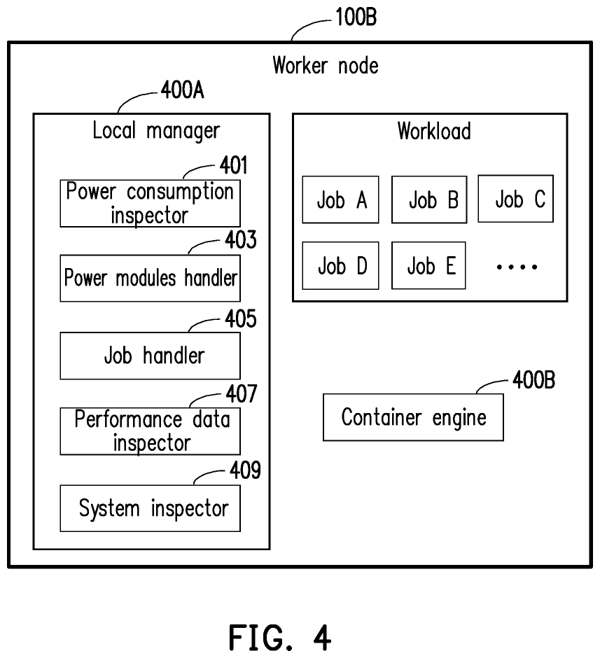

FIG. 4 is a schematic view of an architecture of worker nodes according to an embodiment of the disclosure. Referring to FIG. 4, worker node 100B includes a local manager 400A and a container engine 400B. The local manager 400A regularly checks the workload and execution power consumption on the worker node 100B and actively reports the resource monitoring result (i.e., node resource information) to the resource monitor 120B of the cloud resource allocation apparatus 100A. The container engine 400B is the core of container services, which provides the computing resources required for job execution on the worker node 100B.

The local manager 400A includes a power consumption inspector 401, a power modules handler 403, a job handler 405, a performance data inspector 407, and a system inspector 409.

The power consumption inspector 401 obtains power consumption monitoring data through power monitoring and a dedicated software. For example, the power consumption inspector 401 may obtain host power consumption information through an intelligent platform management interface (IPMI) or an interface using the Redfish standard, analyze the power consumption of each schedule through the Scaphandre tool, obtain load power consumption through the SPECpower and SERT tools developed by the Standard Performance Evaluation Corporation (SPEC), and get the configuration of power governors through CPUFreq or DVFS.

The power modules handler 403 adjusts the system power state, such as one of a powered off mode, a sleep mode, and a specific power consumption mode, in response to the power adjustment suggestion (system level power consumption adjustment) received from the cloud resource allocation apparatus 100A. The power modules handler 403 adjusts the power modules of the worker node 100B based on the instructions of the power planer 321. For example, the power module is adjusted to the powered off mode to achieve maximum energy savings and system repair. The power module is adjusted to the sleep mode to achieve maximum energy savings, and the job time for the next system launch is shortened. The voltage and frequency of the power module is adjusted to achieve the optimal voltage and power consumption of the load.

The job handler 405 executes container lifetime cycle management in response to receiving the resource management command from the resource manager 303 of the cloud resource allocation apparatus 100A. The container lifetime cycle management includes one of container creation, container deletion, and state migration. The job handler 405 knows, through the resource management command transmitted by a resource manager 303, to which job of the application group the process identifier (PID) currently executing container provisioning, deletion, and state migration belongs. In this way, the power consumption inspector 401 is assisted to perform more accurate power consumption inspection on the job schedule, and the performance data inspector 407 is assisted to perform more accurate performance inspection on the job schedule.

The system inspector 409 confirms the system resource usage through system resource monitoring tools such as top, ps, turbostat, sar, pqos, free, vmstat, iostat, netstat, etc., or other auxiliary tools that check resource issues such as memory leaks.

The performance data inspector 407 confirms the container resource usage actually used by each workload of the containers. For example, Kubernetes' metrics-server, cAdvisor, and other resource inspection tools are used to confirm the container resource usage actually used by the workload. The performance data inspector 407 further obtains workload monitoring data based on the system resource usage and the container resource usage.

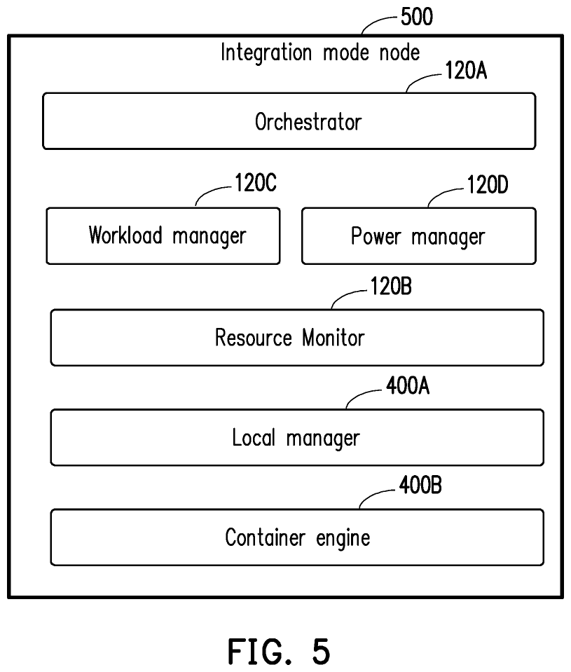

FIG. 5 is a block diagram of integration mode nodes according to an embodiment of the disclosure. In this embodiment, the integration mode node 500 combines the elements of the master node (cloud resource allocation apparatus 100A) and the worker node 100B. The integration mode node 500 includes: an orchestrator 120A, a resource monitor 120B, a workload manager 120C, a power manager 120D, a local manager 400A, and a container engine 400B. The function of each of the elements may refer to FIG. 3 and FIG. 4, and will not be repeated herein.

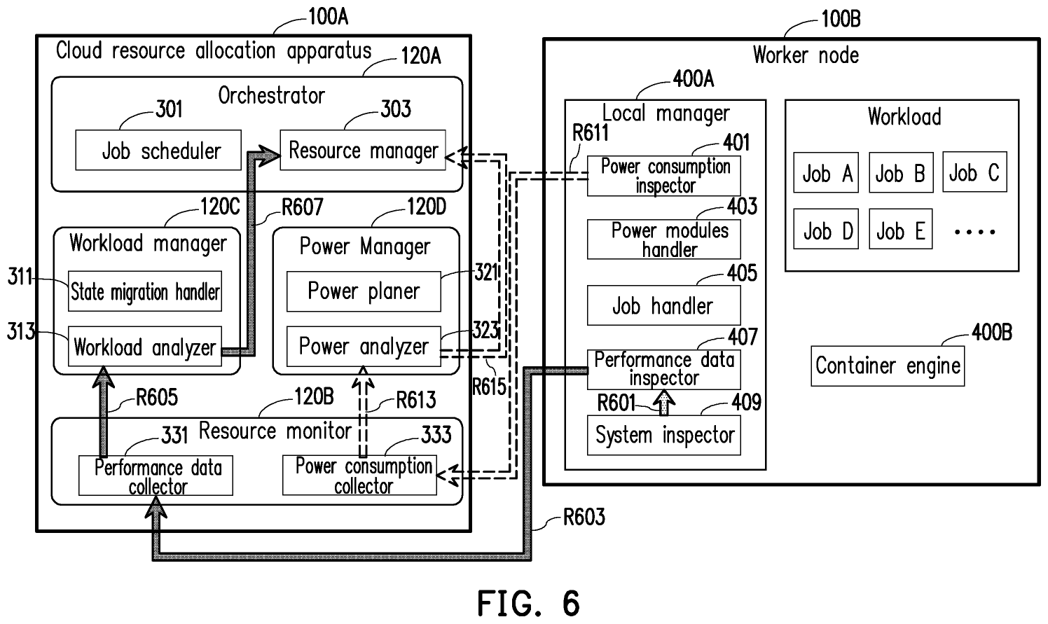

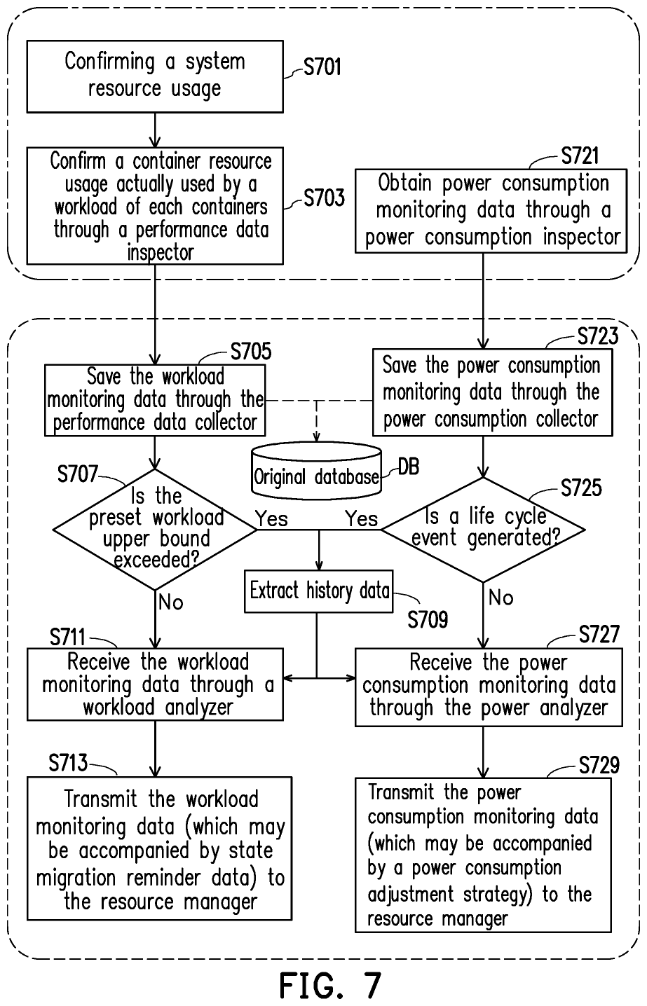

FIG. 6 is a schematic view of performance/power consumption monitoring of worker nodes according to an embodiment of the disclosure. FIG. 7 is a flowchart of the performance/power consumption monitoring of worker node according to an embodiment of the disclosure.

Referring to FIG. 6 and FIG. 7, the process of performance monitoring is first described, and the data flow of performance monitoring is as shown in routes R601, R603, R605, and R607 in FIG. 6.

In the worker node 100B, in step S701, the system inspector 409 confirms the system resource usage. Next, in step S703, the performance data inspector 407 confirms the container resource usage actually used by each of the workloads of the containers, and returns the workload monitoring data including the system resource usage and the container resource usage to the performance data collector 331.

Next, in the cloud resource allocation apparatus 100A, in step S705, the performance data collector 331 saves the workload monitoring data. In addition, in step S707, the performance data collector 331 determines whether the workload monitoring data exceeds the preset workload upper bound. In the case that the workload upper bound is exceeded, in step S709, the performance data collector 331 extracts and puts history data for a period of preset time into the workload monitoring data, and then executes step S711.

Specifically, each of the worker nodes 100B has a workload upper bound, mainly to avoid the phenomenon where the workload of the worker node 100B exceeds the workload upper bound, resulting in a sharp rise in power consumption. For example, the power consumption information corresponding to different workloads in an offline environment may be first measured, and the critical value of the workload that greatly increases the power consumption may be found. The workload upper bound may then be set on the worker node 100B in the formal operating environment (on-line). Alternatively, the resource manager 303 may dynamically adjust the acceptable workload upper bound of each of the worker nodes 100B according to the load type and amount on the worker node 100B through any published or self-designed power consumption model and calculation mechanism.

In the worker node 100B, the performance data inspector 407 determines whether the workload monitoring data exceeds the preset workload upper bound and marks a warning label in the workload monitoring data in response to determining that the workload monitoring data exceeds the workload upper bound. Thereby, the performance data collector 331 in the cloud resource allocation apparatus 100A may append history data to the workload monitoring data based on the preset time in response to detecting that the received workload monitoring data is marked with a warning label.

Next, in step S711, the workload analyzer 313 receives the workload monitoring data. In addition, in step S713, the workload analyzer 313 transmits the workload monitoring data (may be accompanied by state migration reminder data) to the resource manager 303. In response to the workload monitoring data exceeding the preset workload upper bound, the workload analyzer 313 generates the state migration reminder data (source worker node) and transmits the workload monitoring data along with the state migration reminder data to the resource manager 303. In response to the workload monitoring data not exceeding the preset workload upper bound, the workload analyzer 313 does not need to generate the state migration reminder data, but directly transmits the workload monitoring data to the resource manager 303.

In addition, it is further explained that, in the cloud resource allocation apparatus 100A, the resource manager 303 is configured to: trigger a node level state migration in response to the system resource of the source worker node (assumed to be the worker node 100B-1) is missing; and trigger a job group level state migration in response to the excessive workload of the worker node 100B-1; trigger a system level power consumption adjustment in response to the configuration of the power consumption adjustment of the worker node 100B-1 being too high.

The implicit purpose of the node level state migration is that: if there are system resource issues in the worker nodes that need to be repaired, it is necessary to first complete the state migration of all jobs before issuing a system restart command to the node; and since the worker node has plenty available resources, the workload may be concentrated on some of the worker nodes, and the worker nodes without running job is put into sleep mode to achieve energy saving.

The implicit purpose of the job group level state migration is to: balance the workload among multiple worker nodes and try to avoid exceeding the preset workload upper bound; and concentrate the workload on some of the worker nodes, so that the rest of the worker nodes are standby nodes that not requiring to perform node level shutdown or hibernation.

The implicit purpose of the system level power consumption adjustment is to: adjust shutdown, hibernation, and the configuration of the power consumption of the worker nodes.

In response to triggering node level and job group level state migrations, the resource manager 303 takes a job group (e.g., an application group) as the minimum unit and performs resource confirmation before job group transfer. For example, the job group with high priority is processed first. The resource manager 303 determines whether the available resources of the worker nodes 100B other than the worker node 100B-1 meet the resource requirements of the job group.

If the available resources of other worker nodes 100B meet the resource requirements of the job group, the resource manager 303 selects a target worker node (assumed to be a worker node 100B-2) that directly meets the resource requirements of the job group and with the best performance/the least power consumption increase from other worker nodes.

If the available resource of none of the other worker nodes 100B meets the resource requirements of the job group while the resource preemption condition is satisfied, the resource manager 303 selects one or more target worker nodes (assumed to be a worker node 100B-3) corresponding to a single low priority job or multiple low priority jobs according to the order of low priority to high priority among multiple running jobs in other worker nodes 100B.

Afterwards, the resource manager 303 notifies the job scheduler 301 of the job group information, the source worker node, the job group information of the preempted resource, the target worker node, etc., that currently intend to perform state migration. The job scheduler 301 updates the contents of the waiting queue and running queue. Afterwards, the state migration between the source worker node and the target worker node is executed according to a startup sequence and/or a shutdown sequence of the job group defined by the job profile.

Then, respective job handlers 405 of the source worker node and the target worker node activate or deactivate corresponding container services sequentially through respective container engines 400B thereof according to the instructions of the resource manager 303. For example, according to the dependency of the startup sequence of the job group, the corresponding container service is pre-activated through the container engine 400B of the target worker node. According to the dependency of the shutdown sequence of the job group, the operation mode is frozen and transferred through the container engine 400B of the source worker node. According to the dependency of the startup sequence of the job group, state migration is executed through the respective container engines 400B of the source worker node and the target worker node. According to the dependency of the shutdown sequence of the job group, the container services are deactivated one by one through the container engine 400B of the source worker node, and the occupied resources of the container services are released.

In response to executing the node level state migration and determining to repair the system resource issue, the resource manager 303 notifies the power modules handler 403 of the source worker node to execute shutdown to save energy to the greatest extent, or alternatively, continues the normal boot process after shutdown to repair the system resource issue.

In response to executing the node level state migration, which is determined not to be used for repairing the system resource issue, the resource manager 303 notifies the power modules handler 403 of the source worker node to enter sleep mode to store the system state on a hard disk, which may also save energy to the greatest extent and greatly reduce the time for the source worker node to go online again afterwards.

In the cloud resource allocation system 100A, the workload analyzer 313 analyzes the received workload monitoring data of the worker node 100B-1 and detects that the workload monitoring data of the worker node 100B-1 exceeds the preset workload upper bound (excessive workload). At this time, the workload analyzer 313 generates a job group level state migration reminder data (source worker node with state migration requirements) and transmits the state migration reminder data to the resource manager 303. Afterwards, the resource manager 303 generates and transmits a state migration command (including the source worker node, the job group to execute the state migration on the source worker node, and the target worker node with the best performance/the least power consumption increase) according to the state migration reminder data (the source worker node requiring state migration) to the state migration handler 311.

Next, the process of power consumption monitoring is described with reference to FIG. 6 and FIG. 7, and the data flow of the power consumption monitoring is as shown in routes R611, R613, and R615 in FIG. 6.

In worker node 100B, in step S721, the power consumption inspector 401 obtains and reports the power consumption monitoring data to the power consumption collector 333.

Next, in the cloud resource allocation apparatus 100A, in step S723, the power consumption collector 333 saves the power consumption monitoring data. In step S725, the power consumption collector 333 determines whether a life cycle event is generated. If a life cycle event occurs, in step S709, the power consumption collector 333 extracts and puts a period of history data (related to power consumption) for a period of preset time from the original database DB and into the power consumption monitoring data, and then executes step S727.

Specifically, if a container life cycle event (e.g., creation, preemption, termination, etc.) occurs on the worker node 100B, a PID change occurs and the job handler 405 configured to execute container provisioning, deletion, and state migration notifies the power consumption inspector 401 of the PID information (including the job information of the application group) to indicate the power consumption inspector 401 to put the PID information into the power consumption monitoring data. Accordingly, the power consumption collector 333 may determine whether a life cycle event is generated by detecting whether the PID in the power consumption monitoring data changes.

Next, in step S727, the power analyzer 323 receives the power consumption monitoring data. In addition, in step S729, the power analyzer 323 transmits the power consumption monitoring data (which may be accompanied by a power consumption adjustment command) to the resource manager 303. In response to a life cycle event being generated, the power analyzer 323 generates power consumption adjustment reminder data and transmits the power consumption monitoring data along with the power consumption adjustment command to the resource manager 303. In the absence of life cycle events, the power analyzer 323 does not need to generate the power consumption adjustment reminder data, but directly transmits the power consumption monitoring data to the resource manager 303.

In the process of performance and power consumption monitoring, in addition to the preservation of the monitoring data, as long as it is found that the workload exceeds the workload upper bound and/or the life cycle state changes, the execution of the performance/power consumption analysis on the worker nodes is triggered.

If the workload analyzer 313 or the power analyzer 323 finds the history data (indicating that it has been run in the past) during the parsing of the workload monitoring data or the power consumption monitoring data, the average performance and average power consumption of the job executed by the application are obtained to select the target worker node with the best performance and/or the least power consumption increase from the worker nodes that meet the requirement. Thus, in the process of direct resource allocation and container provisioning, high performance and energy-saving are both considered.

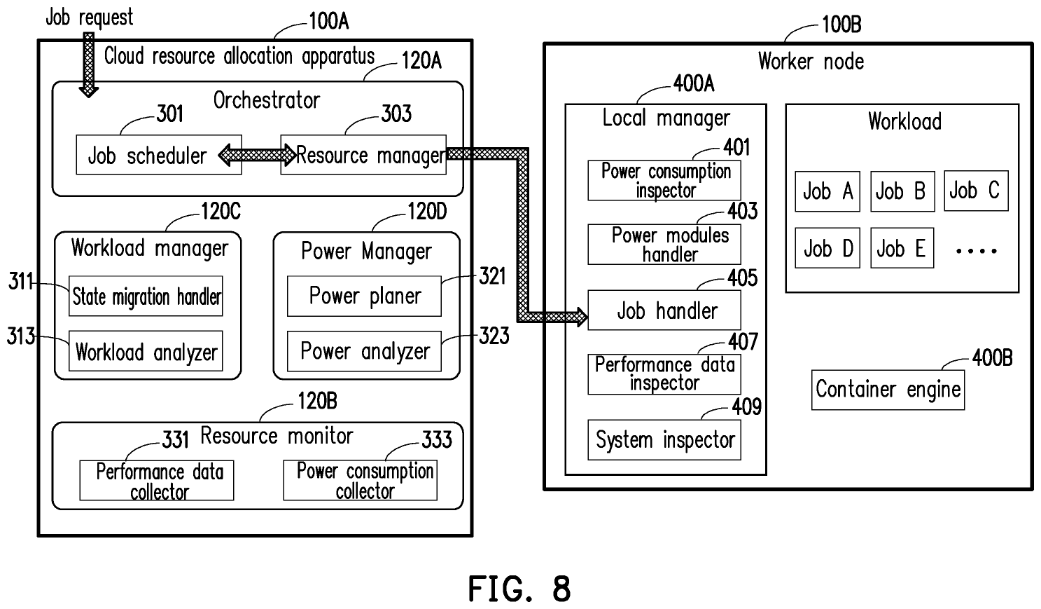

FIG. 8 is a schematic view of a container resource request and a resource orchestration according to an embodiment of the disclosure. Referring to the arrows shown in FIG. 8, after receiving the job request, the job scheduler 301 performs scheduling according to the node resource information reported by the resource manager 303. Afterwards, the resource manager 303 notifies the job handler 405 of the worker node 100B, which is the target worker node, according to the scheduling result. The job handler 405 performs container provisioning for the job to be handled through the container engine 400B.

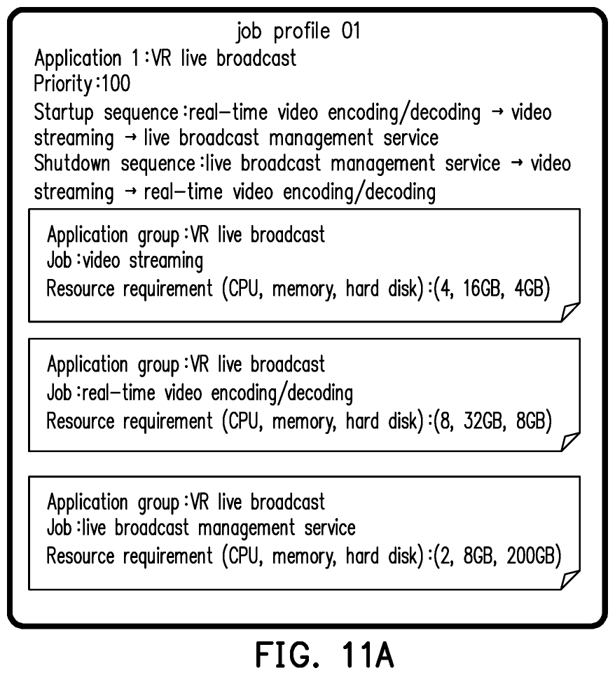

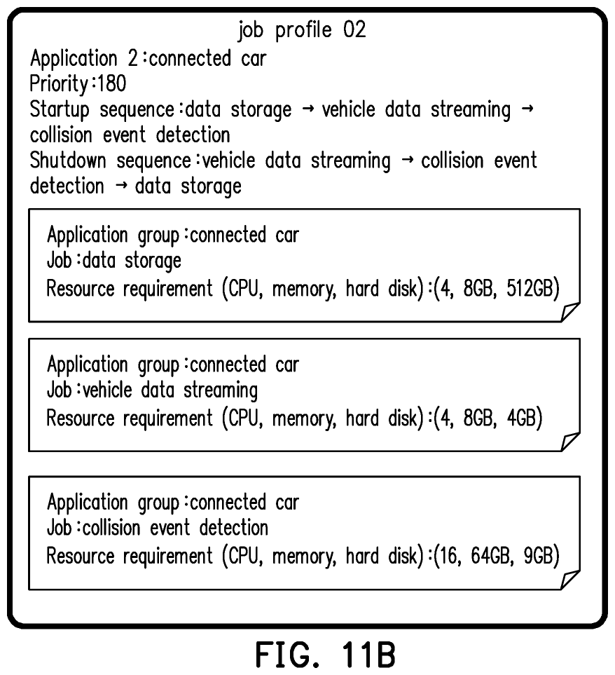

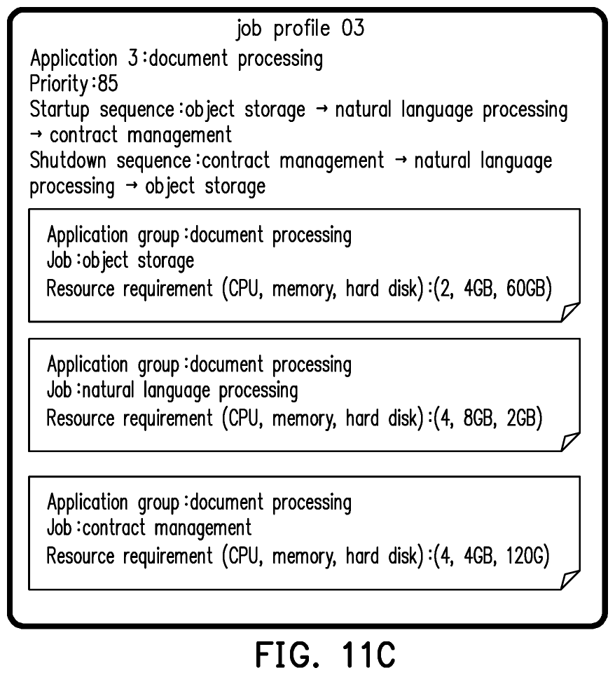

Specifically, after receiving the job request, the job scheduler 301 puts the job request into the waiting queue, then parses the job request to obtain the job profile to know the priority of the application requested by this job request, the startup sequence and shutdown sequence among one or more job containers (belonging to the same application group) included, and the job to be handled and resource requirements corresponding to each of the job containers in the application group (as shown in FIG. 11A to FIG. 11C to be described later).

The job scheduler 301 communicates with the resource manager 303 to know the workload monitoring data and the power consumption monitoring data of all worker nodes 100B and estimate the performance and the power consumption cost of each of the worker nodes 100B for undertaking the job request based on the workload monitoring data and the power consumption monitoring data. If the available resources of the worker nodes 100B meet the resource requirement of the job request, the job scheduler 301 further uses the worker node with the highest energy efficiency (high performance/low power consumption) as the undertaker of the job request. Then, the resource manager 303 notifies the job handler 405 on the worker node 100B, which is the undertaking target, so that the job handler 405 performs container provisioning through the container engine 400B according to the dependencies of the application group members (job container).

In addition, the job scheduler 301 further evaluates the possibility of preempting a low priority job in response to determining that none of the available resource of the worker nodes 100B meets the resource requirement of the job request. If it is necessary to preempt the low priority job, a resource management command is transmitted to the job handler 405 of the worker node 100B corresponding to the low priority job through the resource manager 303, so that the job handler 405 backs up the operation mode of the low priority job based on the resource management command and executes the container lifetime cycle management (the termination of the container herein). After the backup of the operation mode is completed, the resources occupied by the low priority job are released. Afterwards, the job handler 405 performs container provisioning through the container engine 400B according to the dependencies of the application group members (job container).

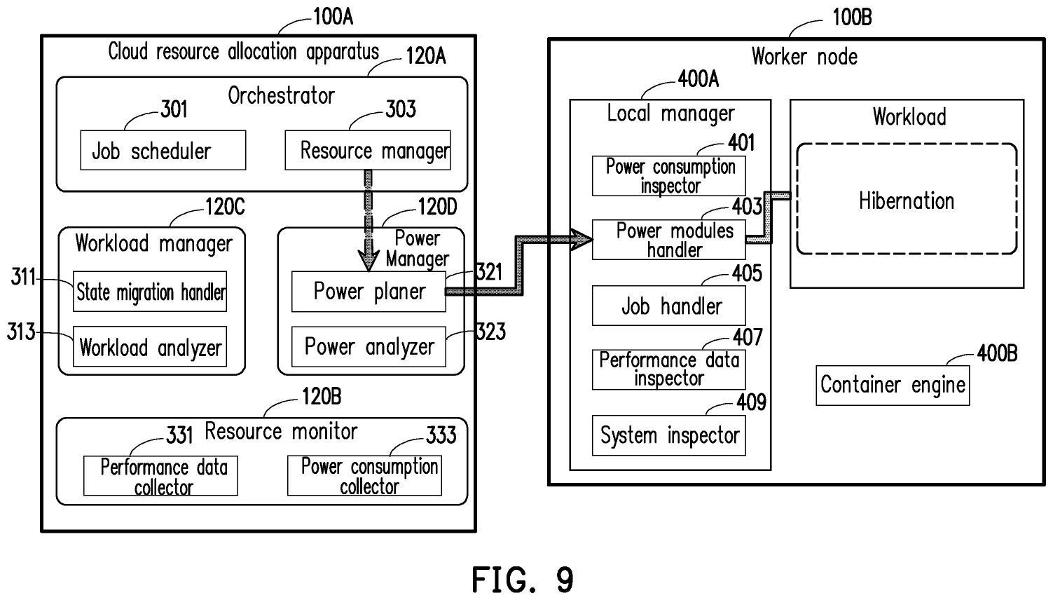

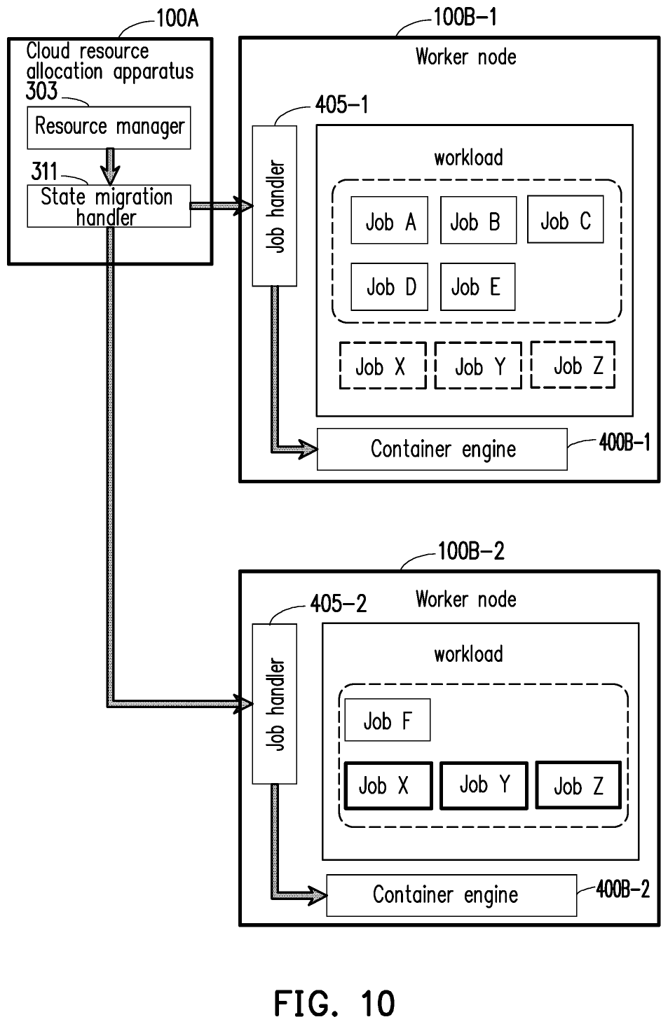

FIG. 9 is a schematic view of power consumption adjustment according to an embodiment of the disclosure. FIG. 10 is a schematic view of performance adjustment according to an embodiment of the disclosure. The following embodiment is described with reference to FIG. 6. The data flow of performance/power consumption monitoring is shown in FIG. 6. The resource manager 303 is the confluence of the performance and power consumption monitoring data (workload monitoring data and power consumption monitoring data) and the performance and power consumption analysis suggestions (state migration suggestions and power adjustment suggestions) of all worker nodes 100B, which act as the resource explorer that actively makes performance and power consumption adjustment decisions. The resource manager 303 decides whether to transmit the state migration command to the state migration handler 311 or transmit the power consumption adjustment strategy to the power planer 321 according to the reports from the workload analyzer 313 and the power analyzer 323.

In FIG. 9, it is assumed that after the power analyzer 323 analyzes the power consumption monitoring data reported by the worker node 100B and determines that the worker node 100B has no power consumption by job schedule after the application requested by the job request is completed, the power analyzer 323 provides the resource manager 303 with the power consumption adjustment strategy. The resource manager 303 transmits the power consumption adjustment strategy to the power planer 321, and the power planer 321 plans a power adjustment suggestion including a command for instructing the worker node 100B to enter sleep mode according to the power consumption adjustment strategy. Afterwards, the power planer 321 transmits the power adjustment suggestion to the power modules handler 403 of the worker node 100B, so that the power modules handler 403 adjusts the system power state of the worker node 100B to sleep mode.

In the worker node 100B, the power consumption inspector 401 determines whether life cycle management events such as container creation, container termination, and container preemption are being executed. If yes, the power consumption inspector 401 marks a label corresponding to the life cycle management event in the power consumption monitoring data. In the cloud resource allocation apparatus 100A, the label corresponding to the life cycle management event in the power consumption monitoring data detected by the power analyzer 323 is used as the basis for the power planer 321 to plan the power adjustment suggestion.

For example, a node level power adjustment suggestion is generated through the power planer 321 in response to the power analyzer 323 detecting that the worker node 100B has no power consumption related to the job schedule based on the power consumption monitoring data. For example, the worker node 100B is made to shut down, sleep, etc.

For example, a system level power adjustment suggestion is generated through the power planer 321 in response to the power analyzer 323 detecting that the configuration of the power consumption adjustment of the worker node 100B is too high based on the power consumption monitoring data (including history data), such as enabling the worker node 100B to adjust the CPU operation frequency or other power consumption adjustments through the DVFS.

FIG. 10 illustrates that the workload of the worker node 100B-1 exceeds the preset workload upper bound. Thus, job X, job Y, and job Z on the worker node 100B-1 are transferred to the worker node 100B-2. In response to the workload of worker node 100B-1 exceeding the preset workload upper bound, the state migration is triggered. In FIG. 10, the architecture of the worker node 100B-1 and the worker node 100B-2 may refer to the worker node 100B shown in FIG. 4, the functions of the job handlers 405-1 and 405-2 may refer to the description of the aforementioned job handler 405, and the functions of the container engine 400B-1 and 400B-2 may refer to the description of the aforementioned container engine 400B.

Specifically, the resource manager 303 controls the node resource information actively reported by all worker nodes 100B. In response to detecting that the workload of the worker node 100B-1 exceeds the preset workload upper bound, the resource manager 303 finds the worker node 100B-2 whose available resource satisfies the job X, job Y, and job Z in worker nodes 100B, and then assign the job X, job Y, and job Z to the worker node 100B-2.

The following are examples in accordance with embodiments of the present disclosure.

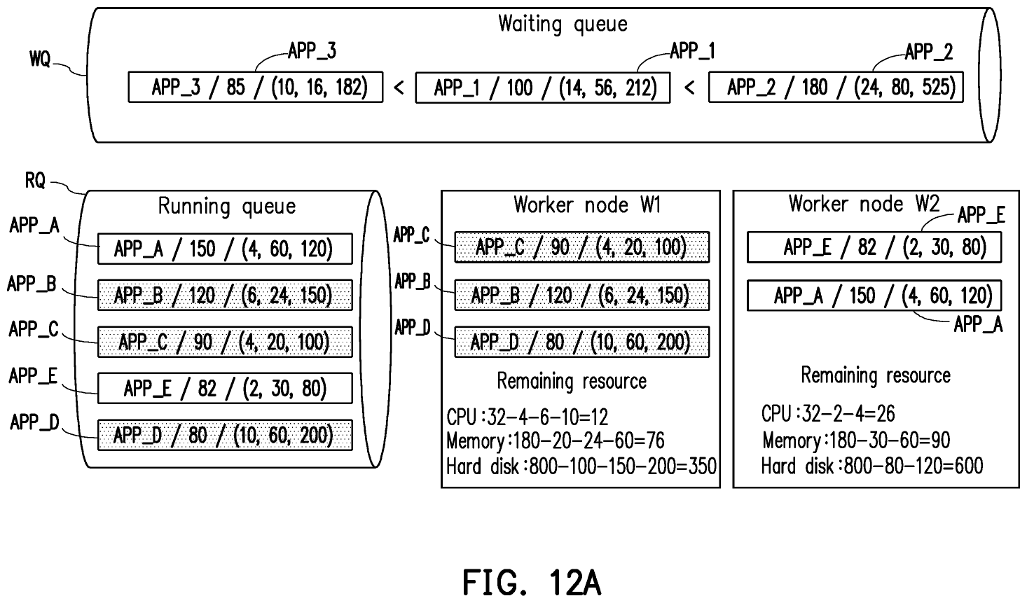

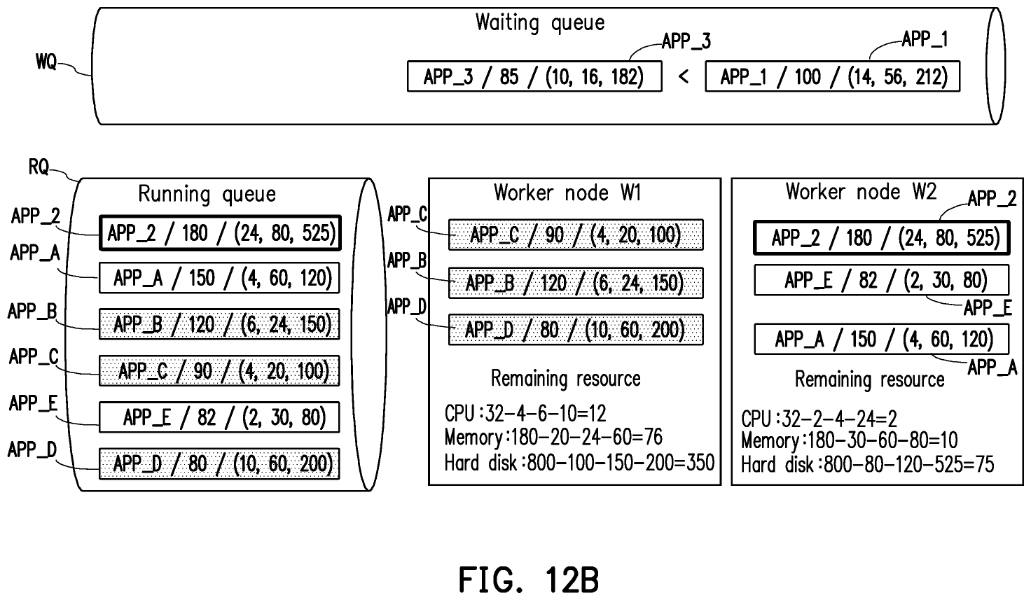

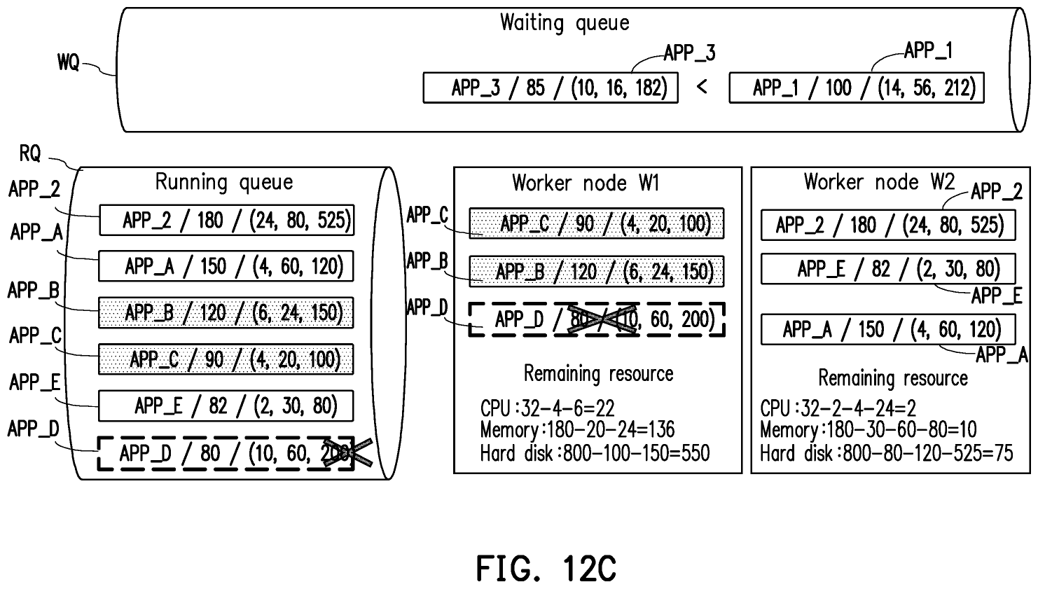

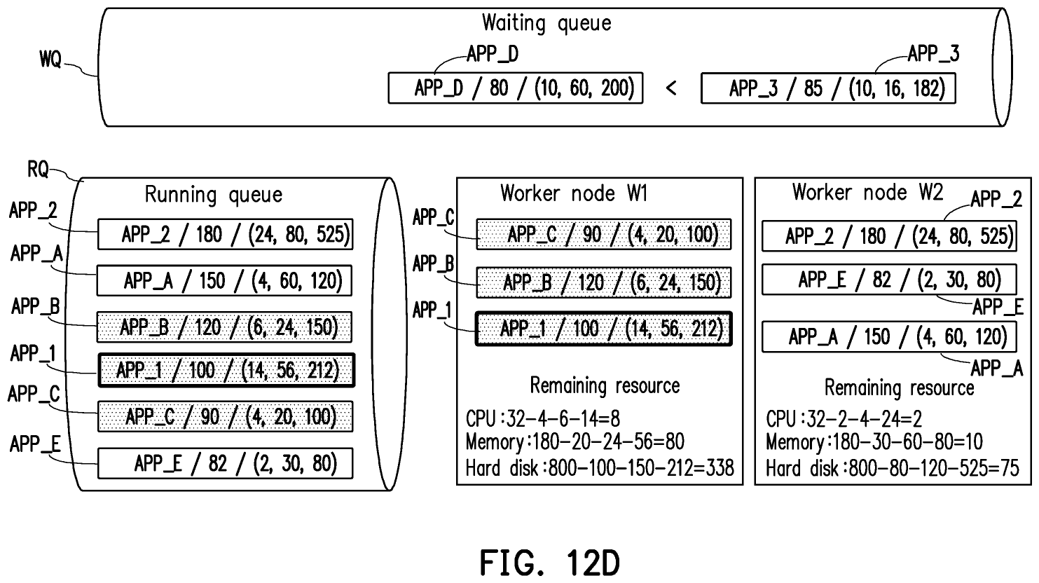

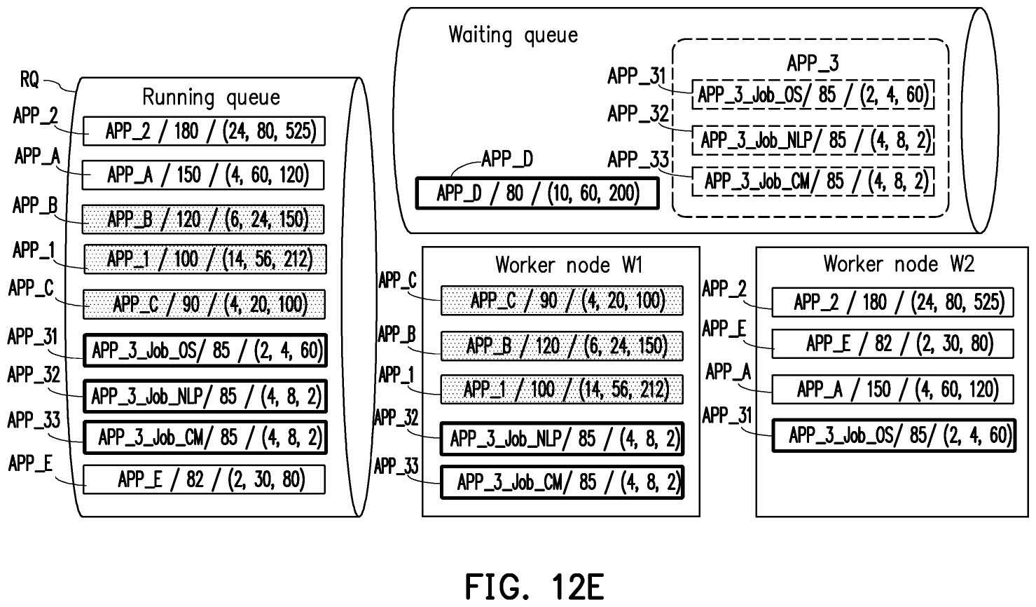

FIG. 11A to FIG. 11C are schematic views of job profiles of job requests according to an embodiment of the disclosure. FIG. 12A to FIG. 12E are the schematic views of distribution of job requests according to an embodiment of the disclosure.

FIG. 11A shows the job profile 1 corresponding to the job request of application 1, “VR live broadcast”, with a priority of 100, which includes an application group of three jobs, including video streaming (VS), real-time video encoding/decoding (RVED), and live broadcast management service (LBMS). The startup sequence of the three application group members (three job containers) of application 1 is “real-time video encoding/decoding→video streaming→live broadcast management service”, and the shutdown sequence is “live broadcast management service→video streaming→real-time video encoding/decoding”. All the resource requirements required by application 1 are 14 for CPU, 56 GB for memory, and 212 GB for the hard disk, which are recorded as “(CPU, memory, hard disk)=(14, 56, 212)”.

For example, in application 1 of “VR live broadcast”, three functions are required: video streaming, real-time video encoding/decoding, and live broadcast management service, which are supported by different container services. Natural dependencies exist between these container services, such as the startup sequence and the shutdown sequence.

FIG. 11B shows the job profile 2 corresponding to the job request of application 2, “connected car”, with a priority of 180, which includes an application group of three jobs, including data storage (DS), vehicle data streaming (VDS), and collision event detection (CED). The startup sequence of the three application group members (three job containers) of application 2 is “data storage→vehicle data streaming→collision event detection”, and the shutdown sequence is “vehicle data streaming→collision event detection→data storage”. All the resource requirements required by application 2 is (CPU, memory, hard disk)=(24, 80, 525).

FIG. 11C shows the job profile 3 corresponding to the job request of application 3, “document processing”, with a priority of 85, which includes an application group of three jobs, including object storage (OS), natural language processing (NLP), and contract management (CM). The startup sequence of the three application group members (three job containers) of application 3 is “object storage→natural language processing→contract management”, and the shutdown sequence is “contract management→natural language processing→object storage”. All the resource requirements required by application 3 is (CPU, memory, hard disk)=(10, 16, 182).

FIG. 12A illustrates the state of a waiting queue WQ, a running queue RQ, a worker node W1, and a worker node W2. In FIG. 12A, the waiting queue WQ includes applications APP_1, APP_2, and APP_3 respectively corresponding to applications 1 to 3 shown in FIG. 11A to FIG. 11C, the priority order is: application APP_2> application APP_1> application APP_3. “APP_3/85/(10, 16, 182)” represents application APP_3, with a priority of 85, and the required resource requirements (CPU, memory, hard disk)=(10, 16, 182), and so on.

There are five running applications APP_A˜APP_E in the running queue RQ. Applications APP_C, APP_B, APP_D run in the worker node W1. The remaining resource of the worker node W1 is (CPU, memory, hard disk)=(12, 76, 350). Applications APP_E and APP_A run in the worker node W2. The remaining resource of the worker node W2 is (CPU, memory, hard disk)=(26, 90, 600).

The job request to be processed waits in the waiting queue WQ, and the request of the application with high priority is prioritized for scheduling.

In the embodiment shown in FIG. 12A, the job scheduler 301 first fetches the application APP_2 from the waiting queue WQ for scheduling. The resource requirements of the application APP_2 are compared with the remaining resources of the worker node W1 and the worker node W2, and the worker node W1 that meets the resource requirements of the application APP_2 is found.

Next, as shown in FIG. 12B, the job scheduler 301 assigns the application APP_2 to the worker node W2 and deletes the job request thereof from the waiting queue WQ, and the application APP_2 is added to the running queue RQ. At this time, the remaining resource of the worker node W2 is (CPU, memory, hard disk)=(2, 10, 75).

Next, the job scheduler 301 fetches the application APP_1 from the waiting queue WQ for scheduling. The resource requirements of the application APP_1 are compared with the remaining resources of the worker node W1 and the worker node W2, and it is determined that neither the worker node W1 nor the worker node W2 meets the resource requirements of the application APP_1. At this time, as shown in FIG. 12C, the job scheduler 301 finds the application APP_D with the lowest priority in the running queue RQ satisfying the resource preemption condition, and then notifies the worker node W1 to back up the operation mode of the application APP_D and release the resources used by the application APP_D. At this time, the remaining resource of the worker node W1 is (CPU, memory, hard disk)=(22, 136, 550), which meets the resource requirement of the application APP_1.

Next, as shown in FIG. 12D, the job scheduler 301 assigns the application APP_1 to the worker node W1 and deletes the job request thereof from the waiting queue WQ, and the application APP_1 is added to the running queue RQ. At the same time, the application APP_D is added to the waiting queue WQ. The application APP_D is sorted after the application APP_3 as the priority thereof is 80, which is less than the priority 85 of the application APP_3. At this time, the remaining resource of the worker node W1 is (CPU, memory, hard disk)=(8, 80, 338). Next, the job scheduler 301 fetches the application APP_3 from the waiting queue WQ for scheduling. The resource requirements of the application APP_3 are compared with the remaining resources of the worker node W1 and the worker node W2, and it is determined that neither the worker node W1 nor the worker node W2 meets the resource requirement of the application APP_3. Moreover, the resource preemption condition is not satisfied as well (i.e., not eligible for executing indirect resource allocation). At this time, the job scheduler 301 executes the direct resource allocation for each of the job containers (belonging to the APP_3 application group) included in the application APP_3.

As shown in FIG. 12E, the application APP_3 includes application group members APP_31, APP_32, and APP_33. “APP_3_Job_OS/85/(2, 4, 60)” shown in the application group member APP_31 represents the job container OS corresponding to the application APP_3, with a priority of 85 and the resource requirement is (CPU, memory, hard disk)=(2, 4, 60). The application group members APP_32 and APP_33 are likewise.

After comparing the resource requirements of the application group members APP_31, APP_32, and APP_33 with the remaining resources of the worker nodes W1 and W2, the job scheduler 301 assigns the application group members APP_32 and APP_33 to the worker node W1 and the application group member APP_31 to the worker node W2.

After that, the job scheduler 301 deletes the application APP_3 from the waiting queue WQ and adds the application group members (job container) APP_31, APP_32, APP_33 to the running queue RQ.

On this basis, if the available resources of the worker node meet the resource requirement of a single application directly, the direct resource allocation is performed. Running applications are added to the running queue RQ for easy management.

If the available resources of the worker node do not meet the resource requirement of a single application directly, preemptive indirect resource allocation is performed. In addition, during the assessment of the low priority job that is preempted, the backup of the operation mode of the low priority job is performed, and the occupied available resource is released. The preempted application (low priority job) enters the waiting queue WQ to wait for subsequent scheduling.

If the available resources of the worker node do not meet the resource requirement of a single application directly and the resource preemption is not possible, the total amount of available resources of all worker nodes are evaluated to determine whether to perform a container level cross-node provisioning (as shown in FIG. 12E). After the execution of the container level cross-node provisioning under the single application, job management is also performed through the running queue RQ.

The logic of group-based preemption is that: firstly, the application group with high priority is considered. That is, the group-based resource arrangement and the preemption are performed on the application with high priority first. In response to the available resource being sufficient, the arrangement is performed directly; in response to the available resource being insufficient, the arrangement is performed preemptively. In addition, for the applications with high priority in the running queue, related application group members thereof (job container) run on the same worker node as much as possible, thereby reducing the communication cost across nodes. Secondly, the resource requirement is considered. For the applications in the waiting queue having lower priority, the available resources scattered on each of the worker nodes are considered at this stage in order to meet the resource requirement as much as possible to support the operation of more applications. The configuration methods of various priorities of the application are as follows: the platform administrator may first analyze the characteristics of the workload and then set the priorities one by one. The priority is also set based on the following considerations, that is, real-time applications for life and property safety (the highest priority), real-time interactive applications (high priority), non-interactive real-time applications (medium priority), and others (low priority). However, the disclosure is not limited thereto.

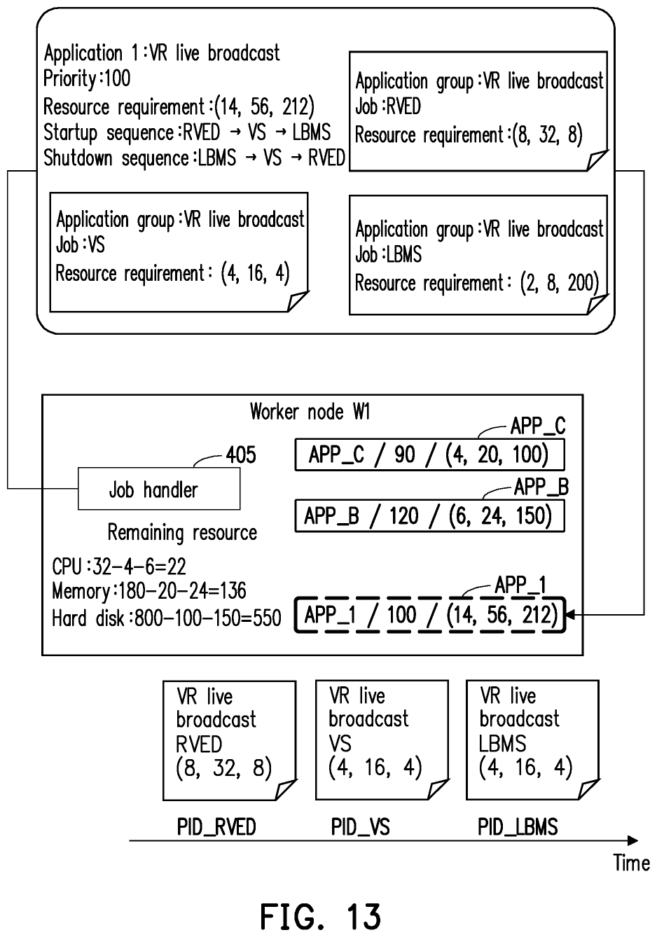

FIG. 13 is a schematic view of job dependency and resource check according to an embodiment of the disclosure. Referring to FIG. 13, the application APP_1 is started on the worker node W1, and the application group members (job container) are assigned PIDs corresponding to RVED, VS, and LBMS, namely PID_RVED, PID_VS, and PID_LBMS, according to the startup sequence.

In addition, during the container provisioning of the job handler 405 on the worker node W1, the job profile 1 of the job request of application 1 “VR live broadcast” as shown in FIG. 11A is received. In addition to sequential provisioning of the containers based on the dependencies of the containers, “performance and power consumption measurement information” at the schedule level, the application level, and the node level and reports are generated through the job schedules of different containers.

The logic of the container provisioning based on the dependencies of the orchestration of the application is that: container provisioning is executed according to the dependencies (e.g., startup sequence, shutdown sequence) of the application group members (job container). Accordingly, in the logic of the execution of the application, the usability of the functions between the container services are ensured.

Under the monitoring architecture of the worker node 100B (the performance data inspector 407 and the power consumption inspector 401), the time difference of the container provisioning service helps to distinguish efficiently the application to which the observed object (process identifier) belongs, thereby improving the accuracy of resource monitoring.

Within the life cycle of the application, the energy efficiency of application execution is obtained. For example, the application energy efficiency=the average performance=the average power consumption.

If the application has a history data (indicating that it has been run in the past), then a target worker node with the best performance and/or the least power consumption increase is selected from the worker nodes that meet the resource requirement based on the historical records of the average performance and the average power consumption. In the process of resource allocation and application provisioning, high performance and energy-saving are both considered.

To sum up, the cloud resource allocation apparatus disclosed in the disclosure has (1) job performance and power consumption monitoring and dynamic adjustment capabilities, and (2) application resource orchestration and group-based job preemption capabilities. Accordingly, the running performance of high priority application services is guaranteed, and the power usage efficiency of computing resources is enhanced at the same time.

The disclosure proposes dynamic performance and power consumption monitoring combined with dynamic state migration and configuration management, which effectively reduces peak phenomenon of node resources and power, thereby prolonging the lifetime of physical servers and equipment resources and providing potential for industrial application. The disclosure proposes to use a higher monitoring frequency to observe and analyze worker nodes with higher load or power consumption. The design of dynamic monitoring and analyzing the frequency effectively checks and analyzes the health of busy worker nodes, thereby reducing the response time of detection error and providing potential for industrial application.

The disclosure has a scheduling mechanism that considers the priorities of the application groups, which enables important application services to be provisioned immediately and ensures the right of running and the execution performance of high priority application services.

What is claimed is:

1. A cloud resource allocation system, comprising a plurality of worker nodes and a master node, wherein the master node comprises:
an orchestrator, configured to:
obtain a plurality of node resource information respectively reported by the worker nodes through a resource manager; and
through a job scheduler, parse a job profile of a job request obtained from a waiting queue and decide to execute a direct resource allocation or an indirect resource allocation for a job to be handled requested by the job request based on the node resource information and the job profile;
wherein in response to deciding to execute the direct resource allocation, the orchestrator is configured to:
find a first worker node having an available resource matching the job profile through the job scheduler among the worker nodes;
dispatch the job to be handled to the first worker node through the resource manager; and
put the job to be handled into a running queue through the job scheduler;
wherein in response to executing the indirect resource allocation, the orchestrator is configured to:
through the job scheduler, find a second worker node having a low priority job among the worker nodes, notify the second worker node so that the second worker node backs up an operation mode of the low priority job, and then release resource used by the low priority job;
put another job request corresponding to the low priority job into the waiting queue through the job scheduler in response to receiving a resource release notification from the second worker node through the resource manager;
dispatch the job to be handled to the second worker node through the resource manager; and
put the job to be handled into the running queue through the job scheduler.

2. The cloud resource allocation system according to claim 1, wherein in the master node, the orchestrator is configured to:
execute the direct resource allocation after determining that the available resource of at least one of the worker nodes meets a resource requirement of the job request based on the node resource information and the job profile through the job scheduler,
wherein in response to deciding to execute the direct resource allocation, the first worker node meeting a job goal is found through the job scheduler, wherein the job goal is a minimum power consumption cost, best performance, or a comprehensive measurement goal.

3. The cloud resource allocation system according to claim 1, wherein in the master node, the orchestrator is configured to:
determine that the available resource of none the worker nodes meets a resource requirement of the job request based on the node resource information and the job profile through the job scheduler, and execute the indirect resource allocation after evaluating that the resource requirement of the job request is met after preempting resources used by one or more running jobs with low priority, wherein the one or more running jobs comprise at least the low priority job;
wherein in response to executing the indirect resource allocation, the second worker node with the low priority job is found through the job scheduler,
notify the second worker node through the job scheduler to continuously release resource used by another low priority job until an adjusted available resource meets the resource requirement of the job request in response to the adjusted available resource that still does not meet the resource requirement of the job request after the second worker node releasing the resource used by the low priority job.

4. The cloud resource allocation system according to claim 1, wherein in the master node, the orchestrator is configured to:
through the job scheduler, execute the direct resource allocation for each of a plurality of application group members in the job profile, in response to determining that none of the worker nodes is eligible for executing the indirect resource allocation after determining that the available resource of none the worker nodes meets a resource requirement of the job request based on the node resource information and the job profile, comprising:
finding a plurality of third worker nodes that meet a resource requirement of the application group members respectively among the worker nodes through the job scheduler;
dispatching each of the application group members to a corresponding third worker node through the resource manager; and
putting the job to be handled into the running queue through the job scheduler.

5. The cloud resource allocation system according to claim 1, wherein the master node further comprises:
a resource monitor, configured to collect the node resource information respectively reported by the worker nodes;
wherein after putting the job to be handled into the running queue through the job scheduler, the orchestrator is configured to:
delete the job to be handled from the running queue through the job scheduler in response to receiving a notification indicating that the job to be handled has ended through the resource manager.

6. The cloud resource allocation system according to claim 1, wherein each of the worker nodes comprises a local manager configured to:
confirm a system resource usage through a system inspector;
confirm a container resource usage actually used by a workload of each containers and obtain workload monitoring data based on the system resource usage and the container resource usage through a performance data inspector;
obtain power consumption monitoring data through a power consumption inspector;
wherein node resource information corresponding to each of the worker nodes comprises the workload monitoring data and the power consumption monitoring data.

7. The cloud resource allocation system according to claim 6, wherein in each of the worker nodes, the local manager is further configured to:
determine whether the workload monitoring data exceeds a preset workload upper bound and mark a warning label in the workload monitoring data through the performance data inspector in response to determining that the workload monitoring data exceeds the preset workload upper bound.

8. The cloud resource allocation system according to claim 7, wherein the master node further comprises:
a resource monitor, configured to: collect the workload monitoring data reported by each of the worker nodes through a performance data collector and append history data to the workload monitoring data based on a preset time in response to the workload monitoring data being marked with the warning label; and
a workload manager, configured to: receive the workload monitoring data from the performance data collector through a workload analyzer and determine whether each of the worker nodes has a resource abnormality by analyzing the workload monitoring data.

9. The cloud resource allocation system according to claim 8, wherein the workload manager is further configured to:
notify the resource manager through the workload analyzer in response to determining that the resource abnormality is a workload excess or a system resource loss, so that the resource manager transmits state migration command to a state migration handler;
generate a job group level state migration suggestion in response to determining that the resource abnormality is the workload excess and generate a node level state migration suggestion in response to determining that the resource abnormality is the system resource loss through the workload analyzer for each of the worker nodes where the resource abnormality occurs.

10. The cloud resource allocation system according to claim 6, wherein the master node further comprises:
a resource monitor, configured to: collect the power consumption monitoring data reported by each of the worker nodes through a power consumption collector; and
a power manager, configured to:
through a power analyzer, receive the power consumption monitoring data from the power consumption collector, obtain a power consumption analysis result by analyzing the power consumption monitoring data, and generate a power consumption adjustment strategy based on the power consumption analysis result; and
generate a power adjustment suggestion based on the power consumption adjustment strategy through a power planer.

11. The cloud resource allocation system according to claim 1, wherein in the master node,
the orchestrator is configured to determine whether the worker nodes are fully loaded based on the node resource information after obtaining the job request through the resource manager;
in response to the worker nodes all being fully loaded, issue a power on command for each of the worker nodes in a sleep mode or a powered off mode through a power manager;
in response to each of the worker nodes in the sleep mode or the powered off mode transitioning to an operation state, reacquire the node resource information respectively reported by the worker nodes through the resource manager.

12. The cloud resource allocation system according to claim 1, wherein each of the worker nodes comprises a local manager configured to:
execute a container lifetime cycle management through a job handler in response to receiving a resource management command from the master node, wherein the container lifetime cycle management comprises one of container creation, container deletion, and state migration;
adjust a system power state through a power modules handler in response to receiving a power adjustment suggestion from the master node, wherein the system power state comprises one of a powered off mode, a sleep mode, and a specific power consumption mode.

13. A cloud resource allocation apparatus, comprising:
a storage, storing an orchestrator and providing a waiting queue and a running queue, wherein the orchestrator comprises a resource manager and a job scheduler; and
a processor, coupled to the storage, configured to:
obtain a plurality of node resource information respectively reported by a plurality of worker nodes through the resource manager; and
parse a job profile of a job request obtained from the waiting queue through the job scheduler and decide to execute a direct resource allocation or an indirect resource allocation for a job to be handled requested by the job request based on the node resource information and the job profile;
wherein in response to deciding to execute the direct resource allocation, the processor is configured to:
find a first worker node having an available resource matching the job profile among the worker nodes through the job scheduler;
dispatch the job to be handled to the first worker node through the resource manager; and
put the job to be handled into the running queue through the job scheduler;
wherein in response to execute the indirect resource allocation, the processor is configured to:
through the job scheduler, find a second worker node having a low priority job among the worker nodes, notify the second worker node so that the second worker node backs up an operation mode of the low priority job, and then release resource used by the low priority job;
put another job request corresponding to the low priority job into the waiting queue through the job scheduler in response to receiving a resource release notification from the second worker node through the resource manager;
dispatch the job to be handled to the second worker node through the resource manager; and
put the job to be handled into the running queue through the job scheduler.

14. A cloud resource allocation method, comprising:
executing the following through a cloud resource allocation apparatus:
obtaining a plurality of node resource information respectively reported by a plurality of worker nodes; and;
parse a job profile of a job request obtained from a waiting queue and deciding to execute a direct resource allocation or an indirect resource allocation for a job to be handled requested by the job request based on the node resource information and the job profile;
wherein deciding to execute the direct resource allocation comprises:
finding a first worker node having an available resource matching the job profile among the worker nodes;
dispatching the job to be handled to the first worker node; and
putting the job to be handled into a running queue;
wherein executing the indirect resource allocation comprises:
finding a second worker node having a low priority job among the worker nodes, notify the second worker node so that the second worker node backs up an operation mode of the low priority job, and then release resource used by the low priority job;
putting another job request corresponding to the low priority job into the waiting queue in response to receiving a resource release notification from the second worker node;
dispatching the job to be handled to the second worker node; and
putting the job to be handled into the running queue.

15. The cloud resource allocation method according to claim 14, wherein executing the direct resource allocation or the indirect resource allocation for the job to be handled based on the node resource information and the job profile comprises:
determining whether the available resource of at least one of the worker nodes meets a resource requirement of the job request based on the node resource information and the job profile
wherein executing the direct resource allocation after determining that the available resource of at least one of the worker nodes meets the resource requirement of the job request comprises:
finding the first worker node meets a job goal, wherein the job goal is a minimum power consumption cost, best performance, or a comprehensive measurement goal.

16. The cloud resource allocation method according to claim 15, wherein after determining whether the available resource of at least one of the worker nodes meets the resource requirement of the job request, further comprises:
determining that the available resource of none the worker nodes meets the resource requirement of the job request based on the node resource information and the job profile and execute the indirect resource allocation after evaluating that the resource requirement of the job request is met after preempting resources used by one or more running jobs with low priority, wherein the one or more running jobs comprise at least the low priority job;
wherein executing the indirect resource allocation comprises:
finding the second worker node having the low priority job; and
notifying the second worker node to continuously release resource used by another low priority job until an adjusted available resource meets the resource requirement of the job request in response to the adjusted available resource that still does not meet the resource requirement of the job request after the second worker node releasing the resource used by the low priority job.

17. The cloud resource allocation method according to claim 15, further comprising executing the following through the cloud resource allocation apparatus:
executing the direct resource allocation for each of a plurality of application group members in the job profile in response to determining that none of the worker nodes is eligible for executing the indirect resource allocation after determining that the available resource of none the worker nodes meets the resource requirement of the job request based on the node resource information and the job profile, comprising:
finding a plurality of third worker nodes that meet a resource requirement of the application group members respectively among the worker nodes;
dispatching each of the application group members to a corresponding third worker node; and
putting the job to be handled into the running queue.

18. The cloud resource allocation method according to claim 14, further comprising executing the following through the cloud resource allocation apparatus:
collecting the node resource information respectively reported by the worker nodes; and
deleting the job to be handled from the running queue in response to receiving a notification indicating that the job to be handled has ended after putting the job to be handled into the running queue.

19. The cloud resource allocation method according to claim 14, further comprising executing the following through each of the worker nodes:
confirming a system resource usage;
confirming a container resource usage actually used by a workload of each containers and obtaining workload monitoring data based on the system resource usage and the container resource usage; and
obtaining power consumption monitoring data;
wherein node resource information corresponding to each of the worker nodes comprises the workload monitoring data and the power consumption monitoring data.

20. The cloud resource allocation method according to claim 19, further comprising executing the following through each of the worker nodes:
determining whether the workload monitoring data exceeds a preset workload upper bound and marking a warning label in the workload monitoring data in response to determining that the workload monitoring data exceeds the preset workload upper bound.

21. The cloud resource allocation method according to claim 20, further comprising executing the following through the cloud resource allocation apparatus:
collecting the workload monitoring data reported by each of the worker nodes and appending history data to the workload monitoring data based on a preset time in response to the workload monitoring data being marked with the warning label; and
determining whether each of the worker nodes has a resource abnormality by analyzing the workload monitoring data.

22. The cloud resource allocation method according to claim 21, wherein after determining whether each of the worker nodes has the resource abnormality, further comprises:
generate a job group level state migration suggestion in response to determining that the resource abnormality is a workload excess and generate a node level state migration suggestion in response to determining that the resource abnormality is a system resource loss for each of the worker nodes where the resource abnormality occurs.

23. The cloud resource allocation method according to claim 19, further comprising executing the following through the cloud resource allocation apparatus:
collecting the power consumption monitoring data reported by each of the worker nodes; and
obtaining a power consumption analysis result by analyzing the power consumption monitoring data and generating a power consumption adjustment strategy based on the power consumption analysis result; and
generating a power adjustment suggestion based on the power consumption adjustment strategy.

24. The cloud resource allocation method according to claim 14, further comprising executing the following through the cloud resource allocation apparatus:
determining whether the worker nodes are fully loaded based on the node resource information after obtaining the job request;
issuing a power on command for each of the worker nodes in a sleep mode or a powered off mode in response to the worker nodes all being fully loaded; and
reacquiring the node resource information respectively reported by the worker nodes in response to each of the worker nodes in the sleep mode or the powered off mode transitioning to an operation state.

25. The cloud resource allocation method according to claim 14, further comprising executing the following through each of the worker nodes:
executing a container lifetime cycle management in response to receiving a resource management command from the cloud resource allocation apparatus, wherein the container lifetime cycle management comprises one of container creation, container deletion, and state migration;
adjusting a system power state in response to receiving a power adjustment suggestion from the cloud resource allocation apparatus, wherein the system power state comprises one of a powered off mode, a sleep mode, and a specific power consumption mode.
